(19) United States
(12) Patent Application Publication
(10) Pub. No.: US 2015/0058441 A1
(43) Pub. Date: Feb. 26, 2015

(54) EFFICIENT CONTENT CACHING MANAGEMENT METHOD FOR WIRELESS NETWORKS

(71) Applicant: SAMSUNG ELECTRONICS CO., LTD., Gyeonggi-do (KR)

(72) Inventors: Yaniv WEIZMAN, Tel-Aviv Jaffa (IL); Itai AHIRAZ, Hod Hashron (IL); Offri GIL, Alfey Menashe (IL)

(73) Assignee: SAMSUNG ELECTRONICS CO., LTD., Gyeonggi-do (KR)

(21) Appl. No.: 13/970,712

(22) Filed: Aug. 20, 2013

(51) Int. Cl. H04L 29/08

(52) U.S. Cl. CPC H04L 67/06
USPC 709/217

(57) ABSTRACT

A pull or push based caching management method that delivers retrieved content over a wireless data network. In its pull mode, distributed cache(s) and mapping modes are deployed, a request for content is received and classified to generate a quality of service (QoS) identifier. The QoS is attached with an identifier for requested content to a content mapping request message. The handling of the mapping request message is scheduled on the mapping node. The content mapping request message transmits to a selected mapping node. The requesting node receives a content mapping reply message. The content request is scheduled on the caching node and a content retrieval request message is transmitted from the requesting node to the one or more target caching nodes. A content retrieval reply message is received in return. In a push mode, instructions are provided for triggering a content retrieval operation and also QoS parameters.

### FIELD OF THE INVENTION

The present invention relates to the field of distributed caching systems. More particularly, the invention relates to a method for ensuring quality of service within a distributed caching system.

### BACKGROUND OF THE INVENTION

The rapid growth of data services, especially real time and Video on Demand (VoD) video services forces wireless network operators to deploy content caching solutions within the network. A distributed caching architecture system, in which caching servers are highly distributed along network entities, is one of the known solution approaches.

Deploying a distributed caching system has significant advantages. First, it caches the content close to network edges, thus reducing the total latency and response time experienced by end users. Secondly, after the content has been accessed for the first time, further accesses for the same content are served locally from the caching entity, thereby allowing data traffic to be offloaded from the usually more congested core network.

Prior art caching systems for cellular networks, or other wireless networks, involve caching within the internal layers of the network or internally to an edge gateway which connects the cellular network to the Internet. Upon receiving a request for a specific content from the end user, the request is navigated along the upper layers of the network, via aggregation points within the network, at which packets are inspected for classifying priority, until reaching the appropriate cache from which the content is delivered. Deploying aggregation points deep within the network, however, results in a higher overhead, i.e. the amount of resources that are consumed in order to identify the Quality of Service (QoS) level for the request and to manage the caching process in the way that is compatible with the identified QoS level.

In 4G networks, such as in 4G Long-Term Evolution (4G LTE—is a standard for wireless communication of high-speed data for mobile phones and data terminals) and WiMax, QoS support defining a priority or performance level for data flow is a fundamental attribute within the standard, such that each service flow is categorized into a service class. This service class is used for prioritization of services both at the access (air interface) and network levels. However, there is no common solution of QoS aware scheduling for different content service types or even between different users profiles (for instance, premium vs. basic) within the highly distributed caching system. Both the processes of discovering a cached content within a distributed network and delivering it to the requesting node are simply not QoS aware, since QoS is currently supported only in different levels of the network elements and technologies.

In WiFi networks, the Wireless Multimedia (WMM) extension adds the supports of different types of services within the Access Points and stations over the air interface.

At the network level, two QoS based protocols have been defined: Integrated Services (IntServ) and Differentiated Services (DiffServ). While in IntServ end-hosts signal their QoS needs to the network, DiffServ works on the provisioned-QoS model, where network elements are set up to service multiple classes of traffic with varying QoS requirements.

Most of the solutions for assuring end to end QoS rely on different levels of packet and frame inspection for classifying data traffic into services. For example:
The Generic Routing Encapsulation (GRE—is a tunneling protocol that can encapsulate a variety of network layer protocols inside virtual point-to-point links over an Internet Protocol) header in WiMax, enables to classify a packet to a predetermined service flow.
The Type of Service (ToS) field within the IP header can be used to prioritize packets within (Media Access Control (MAC) header (which are the data fields added at the beginning of a packet in order to turn it into a frame to be transmitted) to different service types both at access and network levels.
Well known TCP/UDP ports can help to assign a service for a packet (video, VoIP, etc).

A fundamental building block of QoS based systems is the partitioning of services into categories, based on the required attributes. Examples for QoS related attributes include: minimum committed bit rate, maximum sustained bit rate, maximum latency, etc. Based on these attributes, service types are scheduled to be handled within network elements with different priorities such that services with tight QoS constraints are scheduled to be handled first, while services with less strict demands are scheduled after. For example, in 802.11e based WiFi system, 4 categories of service types are defined: VoIP (AC_VI), Video (AC_VO), Best effort (AC_BE), and background (AC_BK). A QoS aware scheduling process schedules the service flows to be handled according to service types priority (high to low): VI−>VO−>BE−>BG. Similar service type categories are defined for other QoS based systems such as LTE and WiMax.

In an End to End QoS based system and technologies, the QoS scheduling process is integrated into different network elements, such as routers and gateways and servers, such that QoS support is achieved across the entire network (i.e. End to End).

In order to align to QoS based systems and maintain its end to end QoS support, it would be desirable for a distributed content delivery system to integrate QoS aspects into its both discovery and delivery subsystems, so it can become QoS aware and thus improve the End to End QoS support of the operator's network.

Distributed caching is a known technology for managing Internet data traffic, in order to meet QoS requirements. However, a commitment for delivering content over the Internet at a minimum QoS level, including a minimum data rate, bandwidth and number of channels, is made to the content provider who pays for that service, but not to the end user for who, access to the delivered data is inexpensive, or even free. On the other hand, in wireless mobile networks, a commitment for a minimum QoS level is made to the subscriber (the end user), who pays to receive that QoS level from the service provider. This is a major difference, since the level of QoS awareness of content delivery over the Internet is lower than the required level of QoS awareness of content delivery over a cellular network, or any other wireless network.

None of the mentioned QoS based solutions integrate a highly distributed caching system to be part of the end to end QoS chain in a 4G network. As a result, the network system has difficulty supporting comprehensive End to End oriented QoS based solutions.

It is an object of the present invention to provide a distributed caching management method for delivering content over a wireless network at a predetermined QoS level.

It is an additional object of the present invention to provide a distributed caching system for delivering content over a wireless network that is significantly more inexpensive and involves significantly less overhead than prior art systems.

It is an additional object of the present invention to provide a method for prioritizing the delivery of content over a wireless network at a predetermined QoS level.

Other objects and advantages of the invention will become apparent as the description proceeds.

### SUMMARY OF THE INVENTION

The present invention is directed to a pull based caching management method for delivering retrieved content over a wireless data network, according to which each of a plurality of distributed caches are deployed at corresponding access nodes located at an edge of a wireless network and mapping nodes are deployed, for mapping the location of cached content. When a request for content is received from a mobile device at one of the access nodes which thereby serves as a requesting node, the request is classified to QoS once for each user, to generate a quality of service (QoS) type identifier associated with a user of the mobile device. At the requesting node, the quality of service (QoS) type identifier is received and the received QoS identifier and an identifier of the requested content are attached to a content mapping request message. The handling of the mapping request message is scheduled, based on the priority that corresponds to the QoS type, on the mapping node. Then the content mapping request message is transmitted to a selected mapping node with a corresponding QoS identifier and a content mapping reply message that includes an identifier of one or more target caching nodes at which the requested content is stored, is received at the requesting node, from the selected mapping node. The handling of the content request is scheduled, based on the priority that corresponds to the type of QoS, on the caching node and a content retrieval request message that includes the QoS identifier and the requested content identifier, are transmitted from the requesting node to the one or more target caching nodes. Finally, a content retrieval reply message, together with retrieved content in accordance with the QoS identifier are received in return, at the requesting node.

The requesting node may be adapted to classify the content request according to a service type category by referring to the received QoS type identifier and to add the classified content request to a priority based mapping table repository prior to transmitting the content mapping request message. The selected mapping node may be adapted to classify a priority level of the content mapping request with respect to content mapping requests received from other requesting nodes and to add the classified content mapping request to a priority based mapping table repository prior to transmitting the content mapping reply message.

The handling of the mapping request may be scheduled, based on the priority that corresponds to the QoS type, on the mapping node and based on the priority that corresponds to the QoS type, on the requesting node.

The present invention is also directed to a push based caching management method for delivering retrieved content over a wireless data network, according to which each of a plurality of distributed caches is deployed at corresponding access nodes located at an edge of a wireless network and a plurality of mapping nodes for mapping the location of cached content are deployed at corresponding access nodes, such that each of the mapping nodes is provided with predetermined user-specific instructions for predetermined users, including instructions for triggering a content retrieval operation and also QoS parameters. A content update triggering event message is received at a first of the mapping nodes and mapping information of the updated content is disseminated from the first mapping node to one or more other mapping nodes. Then a content mapping request message that includes a content identifier associated with the updated content, an identifier of one or more target caching nodes at which the updated content is stored, and the user-specific QoS parameters are received from one of the plurality of mapping nodes, at one of the access nodes serving as a requesting node. A content retrieval request message that includes the QoS parameters and the content identifier is transmitted from the requesting node to the one or more target caching nodes and a content retrieval reply message together with retrieved content in accordance with the QoS parameters is received in return, at the requesting node.

The mapping node may be adapted to classify a priority level of dissemination of local and other peer's content mapping tables, to be performed at discrete periods of times. The dissemination of local and other peer's content mapping tables may be scheduled to be performed once every predefined interval.

In both modes, the mapping node may be adapted to obtain a list of caching nodes in which the content is stored, for a highest priority mapping request, and to send the list together with the content mapping reply message.

In both modes, during a discovery phase, a peer holding a cached item may prioritize content delivery to requesting nodes according to quality of service types. An operator may define within the management system any nodes to be prioritized over other nodes.

During a delivery phase, a peer holding a cached item may prioritize content delivery to requesting nodes according to quality of service types. Prioritization may be assisted by a central database, which stores QoS related data for all end users.

The dissemination process may be performed at discrete periods of times, or alternatively once every predefined interval. The dissemination process may be based, for example, on efficient bloom filters for content mapping representation in nodes.

The dissemination of mapping tables may be based on QoS level of content, according to which, the mapping tables with the highest priority content will be disseminated first, and then the remanding mapping tables, according to a descending order of their corresponding priorities.

In both modes, classification may be based on any combination of the QoS categories and classification defined and used within the system, a standalone system for adding the support for QoS, different user profiles, content providers profiles or regional/physical location of entities. The scheduling process may be done in any requesting and replying nodes within both discovery and delivery phases, based on the relevant QoS class of the requesting user.

### BRIEF DESCRIPTION OF THE DRAWINGS

In the drawings:

FIG. 1 is a schematic illustration of a caching management system, according to one embodiment of the present invention;

FIG. 2 is a block diagram that illustrates communication between an access node and a mapping node in a pull based caching management method;

FIG. 3 is a flow diagram of a classification process at a requesting node for the method of FIG. 2;

FIG. 4 is a flow diagram of a scheduling process at a requesting node for the method of FIG. 2;

FIG. 5 is a flow diagram of a classification process at a selected mapping node for the method of FIG. 2;

FIG. 6 is a flow diagram of a QoS aware scheduling process at the selected mapping node for the method of FIG. 2;

FIG. 7 is a flow diagram of a classification process at a mapping node in a push based caching management method;

FIG. 8 is a flow diagram of a scheduling process at a mapping node for the method of FIG. 7;

FIG. 9 is a block diagram that illustrates communication between an access node and a caching node during a content delivery phase;

FIG. 10 is a flow diagram of a classification process at a requesting node for the method of FIG. 9;

FIG. 11 is a flow diagram of a scheduling process at a requesting node for the method of FIG. 9;

FIG. 12 is a flow diagram of a classification process at a caching node for the method of FIG. 9; and

FIG. 13 is a flow diagram of a scheduling process at a caching node for the method of FIG. 9.

### DETAILED DESCRIPTION OF PREFERRED EMBODIMENTS

The caching management system of the present invention comprises a plurality of distributed caches which are all located at a corresponding access node of a wireless network near or at a network edge, which for a cellular network is generally the base station. QoS support is integrated with the discovery and delivery of a cached item.

Heretofore, these access nodes usually handled only the RF (radio) connection with the end users, i.e. the connection with the mobile devices, and did not handle or manage any caching services. A request for content was necessarily directed to an inter-network aggregation point whereat the request was classified according to a guaranteed user-specific QoS and injected with content from a cache, involving significant excess overhead as a result of the routing and processing operations that greatly consume resources.

The caching management system of the present invention utilizes the existing communication infrastructure at the network access nodes for providing caching services. Since the access node is already configured to take into consideration a previously committed user-specific QoS when allocating RF communication channels for the end users (hereinafter is “QoS aware”), managing the distributed caches that are located at the access nodes requires minimal excess overhead for the wireless network. According to this approach, upon establishing a connection by the end user to the wireless network in order to receive desired content, the access node has already accessed the content related QoS parameters that are needed to comply with the previously committed user-specific QoS level. This allows giving the appropriate priority and resources both for handling the request, i.e. searching and locating the caching nodes from which the content can be obtained, as well as for prioritizing the content delivery to the end user by selecting one or more caching nodes and scheduling the content delivery from the selected nodes.

The caching management system is preferably designed as an on demand content delivery network in a highly decentralized manner where both the cached item location mapping and the cached items locations are partitioned over multiple distributed entities in the overlay network. This arrangement ensures the selection of closest, i.e. under minimum cost function, overlay network entities for both discovering and delivering of content with inherent reduction of response and latency times. Load balancing is also achieved due to the highly decentralized approach. Finally, a decentralized system enables both system reliability and availability.

Typically, the system design is operable in three main highly decentralized phases, a discovery phase, performed by the discovery (mapping) subsystem, a delivery phase performed by the delivery subsystem, and a scheduling phase. Classification of user requests to QoS classes is done once only for the initial user request and is then used for the both the discovery and delivery phases (exchanges within messages). The scheduling phase is done in any requesting and replying nodes within both discovery and delivery phases, based on the relevant QoS class of the requesting user.

The classification phase handles the classification of content requests into service type categories. The service type categories are used for determining the priority of a request to be handled during the following discovery and delivery phases.

One of the major advantages of the highly distributed solution over access entities, such as LTE/WiMax base stations and WiFi access points, is that the classification phase item is exposed to the QoS level of each request as it is being carried within a service flow identifier within the access entity. As so, the access node can classify a content request type according to the request related service flow, and prioritize the handling of requests using inbound priority queues according to their QoS category or priority.

The classification can be done using any combination of the following:
Based on the QoS categories and classification defined and used within the system. For example, as defined in the Wireless Multimedia extension for WiFi networks and 4G (LTE/WiMax) standard defined service types, or any other QoS based system.
As a standalone system for adding the support for QoS. In that case, the system includes the definition of service types and the classification criteria to classify every request/reply to the related service type.
Based on different user profiles. For example, separation into premium services profile (high priority) and basic service profile (low priority).
Based on content providers profiles. For example separation into premium services profile (high priority) and basic service profile (low priority).
Based on regional/physical location of entities. For example, if an operator would like to prioritize handling of specific region/cluster in its deployment.

At the end of the classification process, the classified request is inserted into a priority based repository table. The QoS aware scheduling process in turn runs over that priority based repository and schedules events for handling based on their priority, such that higher priority events are handled first. This scheduling process is done in any requesting and replying nodes within both discovery and delivery phases, based on the relevant QoS class of the requesting user.

In the discovery phase, a content mapping requesting peer and a content mapping peer will prioritize mapping requests and replies handling accordingly, based on quality of service types. Accordingly, latency sensitive content will be handled prior to best effort like content both at the requesting node and the peer having the cached mapping table, according to prioritization of content, mapping requests and replies. An operator may define within the management system any nodes to be prioritized over other nodes.

In a multi-session multi-unicast multimedia transmission, where content is segmented into multiple segments, each segment, is discovered and fetched independently from other segments, possibly from different sources. This segmentation of content enables a highly efficient delivery system to dynamically adjust to network conditions by selecting different content sources, while discovering and retrieving multiple segments from multiple sources.

In the delivery phase, a requesting peer and a peer holding a cached item will prioritize the content request and delivery to requesting nodes accordingly, based on quality of service types. That means that latency sensitive content such as video traffic will be handled and delivered prior to best effort like content such as Internet traffic both at the requesting node and the peer having the cached item. Moreover, an operator may define within the management system any nodes to be prioritized over other nodes.

In a multi-session multi-unicast multimedia transmission, such as HTTP Live Streaming (HLS), where content is segmented into multiple segments, each segment, in turn, is discovered and fetched independently from other segments, possibly from different sources. That important segmentation attribute of content enables a highly efficient delivery system which can dynamically adjust to network conditions by selecting different content sources, even for long live transmissions. However, this flexibility comes with a cost of control information overhead required to discover and retrieve multiple segments from multiple sources.

Opposed to the WiFi networks where QoS support is added as an extension to the existing standard, 4G wireless networks are originally designed to support QoS.

Although being highly efficient delivery system by itself, a QoS based network, such as for advanced mobile operators in 4G LTE and WiMax or carrier WiFi solutions, is required to support an end to end QoS based system supporting different service types categorization of users. Although network elements such as base stations, access nodes and gateways are confronted with these demands, delivery systems such as CDN usually prioritize between content providers rather than between subscribers or between different service types of same subscriber.

As QoS based network operators are required to ensure adequate QoS level for subscribers according to their Service Licensed Agreement (SLA), the QoS support of the caching management system of the present invention is extremely important for assuring and maintaining end to end QoS service over operator networks.

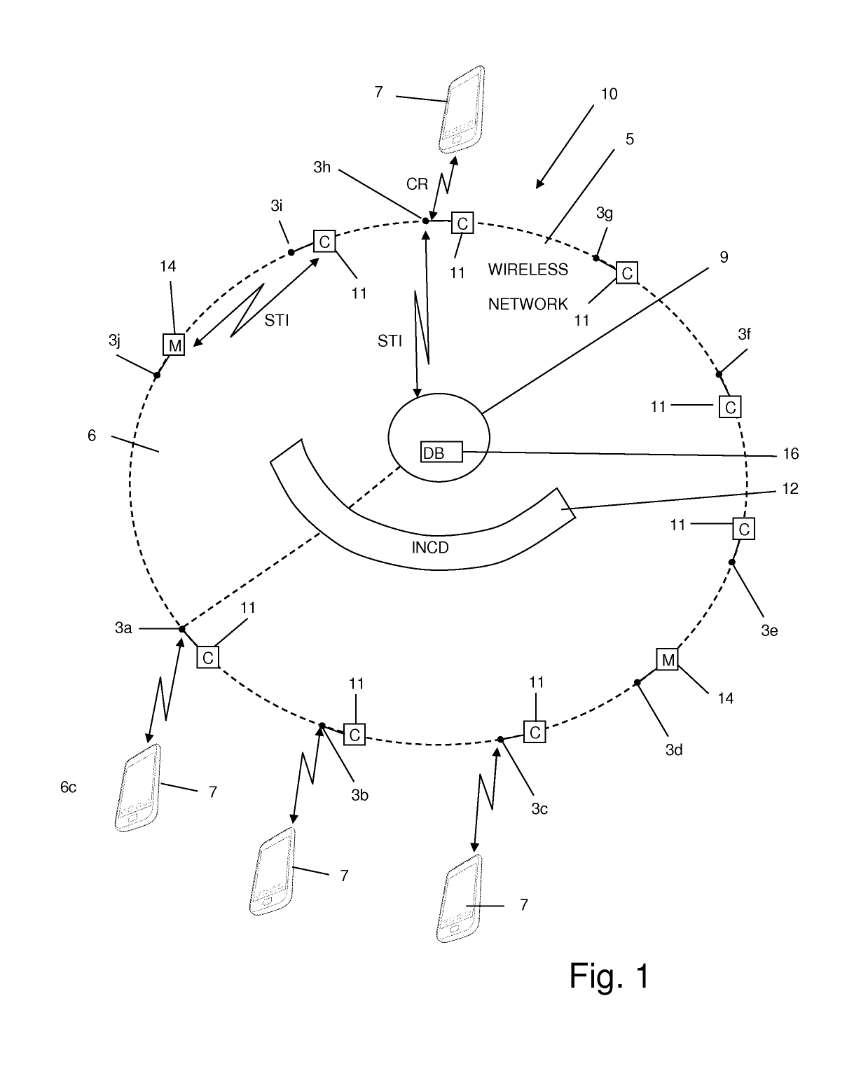

FIG. 1 schematically illustrates the layout of a caching management system, designated generally by numeral 10, according to one embodiment of the present invention. System 10 is adapted to manage the retrieval of data content from a cache and the delivery of the same to a mobile device 7 operating over a wireless network 5.

The boundary of wireless network 5 is delimited by edges 6, which are represented by a dashed line. Core region 9 is provided within a central portion of network 5, and comprises high capacity switches and transmission equipment. Along the network edges 6 are deployed a plurality of access nodes 3a-j, each of which may be a base station for a cellular network or any other suitable gateway device by which a wireless connection is established between a mobile device 7 and network 5. A plurality of inter-network communication devices (INCD) 12 for routing and establishing multi-channel connections manages the flow of data between core region 9 and each of the access nodes.

Access nodes 3a-j are equipped with a component of caching management system 10, in addition to the existing communication infrastructure. Most of the access nodes, e.g. access nodes 3a-c and 3e-i, are provided with one or more corresponding caches 11 in which data content is dynamically storable and from which the cached content is retrievable. Portions of the same content may be stored in different caches and then reassembled prior to delivery. Other access nodes, e.g. access nodes 3d and 3j, are provided with caching related processing equipment 14 for mapping the location of cached content and for prioritizing the delivery of the cached content to an end user, and will be referred hereinafter as “mapping nodes”. A mapping node is generally, but not necessarily, responsible for prioritizing the delivery of cached content through predetermined access nodes. A mapping node may be located at the same access node as a cache.

To further improve the performance of a distributed caching system, content may be shared among caches 11 so that it may be retrieved from a best available caching entity. That will further improve response time and further reduce the load on core region 9 in the case of additional load between edge entities, which are usually less congested.

The prioritization may be assisted by a central database 16 located within core region 9, in which is stored QoS related data for all end users. The QoS related data is generally a user-specific service type identifier. The service type identifier is the output of an algorithm that processes various QoS parameter values such as minimum data rate, bandwidth, resolution and number of channels that have been guaranteed to the end user during content delivery over wireless network 5, wherein the output identifier is a predetermined service type class that is indicative of the combination of guaranteed parameter values. Upon receiving a content request CR from a mobile device 7, the server of the access node that received the content request or is responsible for delivering retrieved content to an end user (hereinafter the “requesting node”) accesses the service type identifier STI associated with the end user who submitted the content request from database 16 and forwards the same to a mapping node for further processing. Alternatively, each access node may be provided with a corresponding service type identifier database 16.

QoS Aware Content Discovery Phase

The content discovery phase within the caching management can be performed in a pull based mode, in a push based mode, or by a combination of the two.

Pull Mode

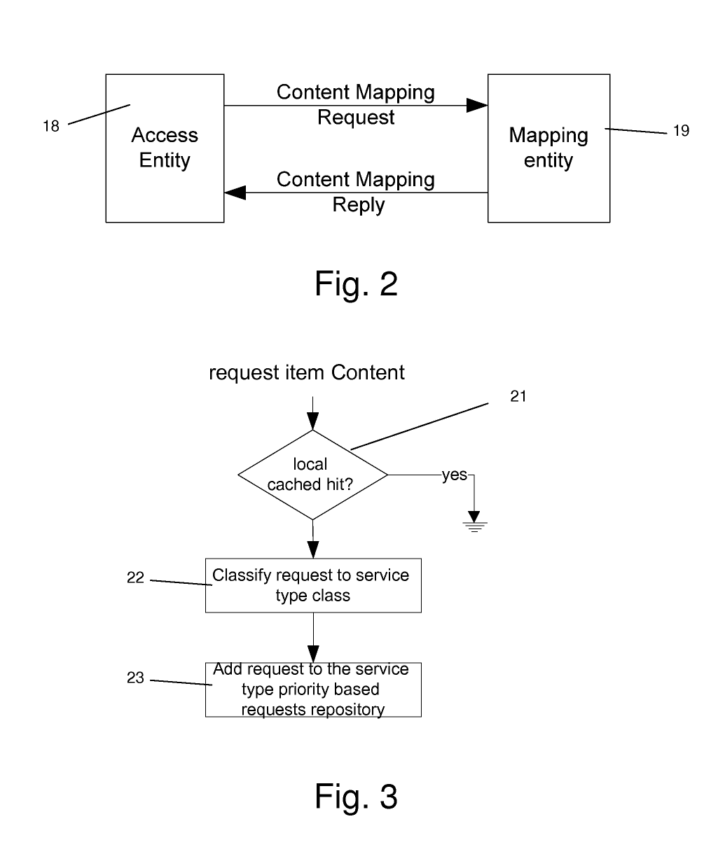

A pull based content discovery operation is illustrated in FIG. 2. After requesting node 18 receives a request for content that is not stored in a local cache, requesting node 18 transmits an explicit content mapping request message to mapping node 19 and then receives in return a content mapping reply message. The requesting node receives the service type identifier associated with the end user who submitted the content request and attaches it to the content mapping request message. A content identifier is also attached to the content mapping request message. The reply message includes an identifier of those nodes at which the required content is stored.

FIG. 3 illustrates the classification process at a requesting node 18.

Upon reception of a new content request:
1. If the requested content, preferably including content type and committed resolution, is locally cached (a local cache hit) in step 21, the process is terminated. Otherwise,
2. Classifying the content request to a service type category in step 22 by referring to the retrieved service type identifier.
3. Adding the classified content request to a “waiting to be handled”, priority based repository table. The repository table will be used by the QoS aware scheduling process.

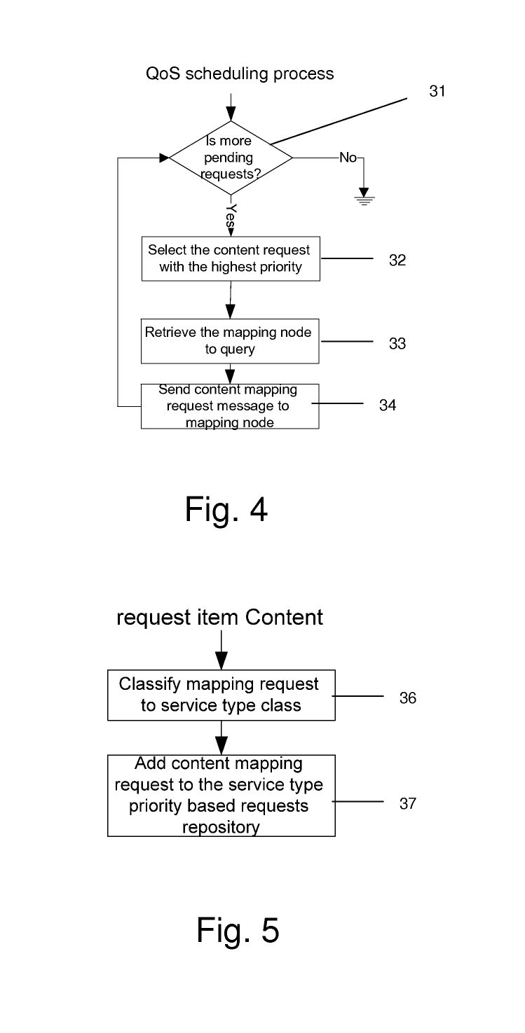

FIG. 4 illustrates the QoS aware scheduling process at the requesting node 18.

Upon start of the scheduling process:
1. If no more pending content requests remain in the repository table, the process is terminated in step 31. Otherwise,
2. Selecting the content request in step 32 with the highest priority based on service type category.
3. Selecting a mapping node to process a content mapping request message in step 33, based on a Distributed Hash Table (DHT) mechanism or some other selection mechanism.
4. Sending the content mapping request message, to which is attached the associated service type identifier, to the selected mapping node in step 34. The service type identifier will be used by the selected mapping node during its classification operation.

FIG. 5 illustrates the classification process at the selected mapping node 19, and includes the steps of:
1. Classifying a priority level of the content request in step 36 using the service class identifier in the received mapping message, with respect to mapping messages received from other requesting nodes.
2. Adding the classified mapped request into a “waiting to be handled”, priority based mapping request repository table in step 37. The repository table will be used by the QoS aware scheduling process.

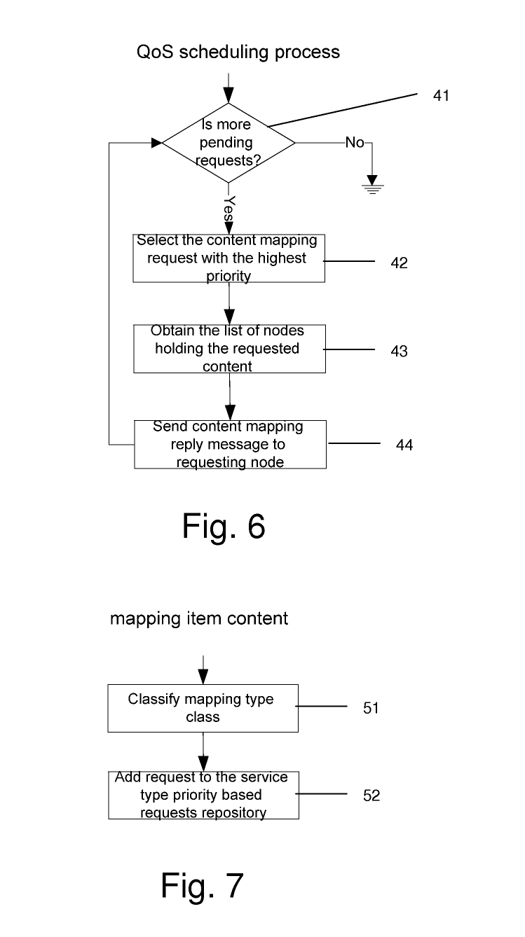

FIG. 6 illustrates the QoS aware scheduling process at the mapping node 19.

Upon start of the scheduling process:
1. If no more pending mapping requests remain in the repository table, the process is terminated in step 41. Otherwise,
2. Selecting in step 42 the mapping request with the highest priority based on the service class identifier.
3. Obtaining in step 43, after searching, a list of nodes associated with a cache in which the requested content is stored.
4. Sending the content mapping reply message in step 44 together with the list of caching entities to the requesting node.

Push Mode

A push based content discovery operation uses implicit mapping procedures. Each mapping node is provided with predetermined user-specific instructions, including instructions for triggering a content mapping operation based on QoS parameters. A content storing event, after content has been transmitted to one of the caches for example via the Internet and has been stored therein, may initiate the push based content discovery operation. Following the content storing event, a triggering event message is transmitted to a mapping node and then every mapping node disseminates its known content mapping tables (locally and on other nodes) to other mapping nodes. A triggering event may also be based on updates received from other nodes, as well as on local updates based on new available cached content. Alternatively, a triggering event may be time based.

The dissemination of mapping tables may be also based on QoS level of content, according to which, the mapping tables with the highest priority content will be disseminated first, and then the remanding mapping tables, according to a descending order of their corresponding priorities.

The dissemination process is preferably not continuous in order to minimize utilization of network resources. Since it is subject to control overhead over the network, the dissemination process may be performed at discrete periods of times, or alternatively once every predefined interval. The dissemination process may be based on for example efficient bloom filters for content mapping representation in nodes.

For aligning with the QoS based system, the dissemination process may be initiated at different intervals based on content type categories, so that data associated with high priority content categories, e.g. video, will be disseminated at shorter intervals while data associated with less critical, lower priority content, will be disseminated at relatively longer intervals.

FIG. 7 illustrates the classification process within a mapping node. Following a triggering event,
1. Classifying in step 51 the content retrieval operations according to service type category of user targeted to receive the content to be retrieved, and according to a content type identifier included in a triggering event message, for providing a secondary classification within a specific service type category.
2. Adding the classified content retrieval operations into a “waiting to be handled”, priority based content retrieval operation repository table in step 52.

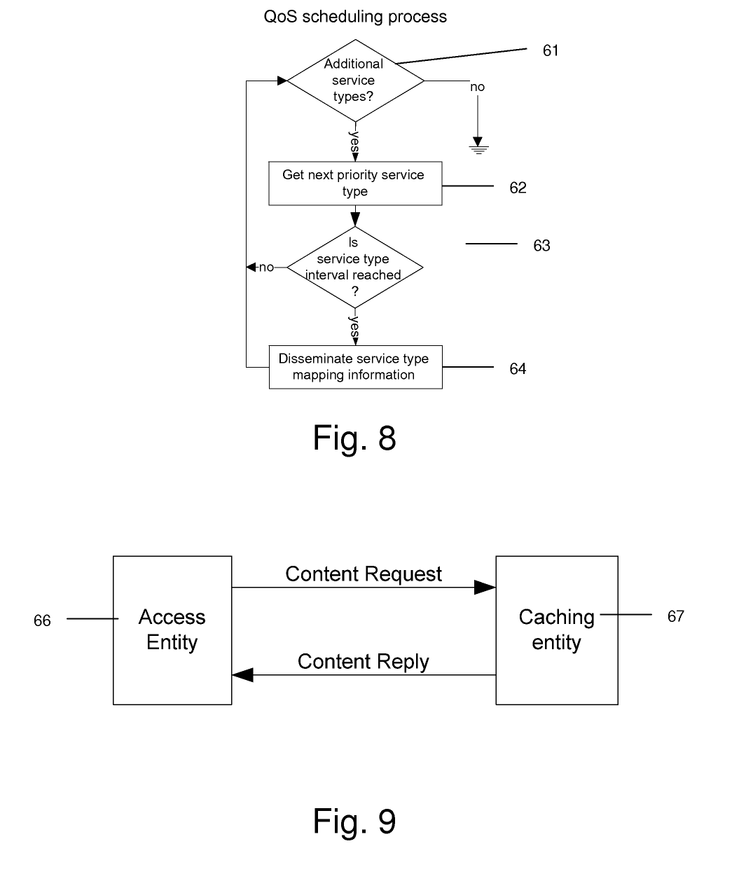

FIG. 8 illustrates the QoS aware scheduling process within a mapping node. For all service type categories:
1. Ending process in step 61 if all service type categories have been exhausted. Otherwise,
2. Accessing next-priority service type categories in step 62.
3. Accessing next-priority service type in step 63 if the predetermined service type category interval has not elapsed. Otherwise,
4. Disseminating mapping information in step 64 of content related to the presently accessed service type category.

It will be appreciated that a mapping node may operate in both push and pull modes, depending on user demands and event conditions, requiring the scheduling processed to be suitably coordinated.

QoS Aware Content Delivery Phase

During the delivery phase, a prioritization process is performed to prioritize between users, based on their corresponding QoS parameters. In addition, prioritization can be performed according to different types of content, requested by different users.

Content delivery scheduling is performed according to known QoS parameters. Following completion of the mapping process, the access node selects a caching node in which is stored the required content to be retrieved.

As illustrated in FIG. 9, an explicit content retrieval request message and content retrieval reply message are exchanged between a requesting node 66 and caching node 67. Requesting node 66, after receiving mapping information from a mapping node, transmits the content retrieval request message to caching node 67, and then receives in return the content retrieval reply message. The request message includes the required content identifier and service type identifier, and the retrieved content is then transmitted together with the reply message.

Classification and scheduling procedures are processed at both requesting node 66 and caching node 67.

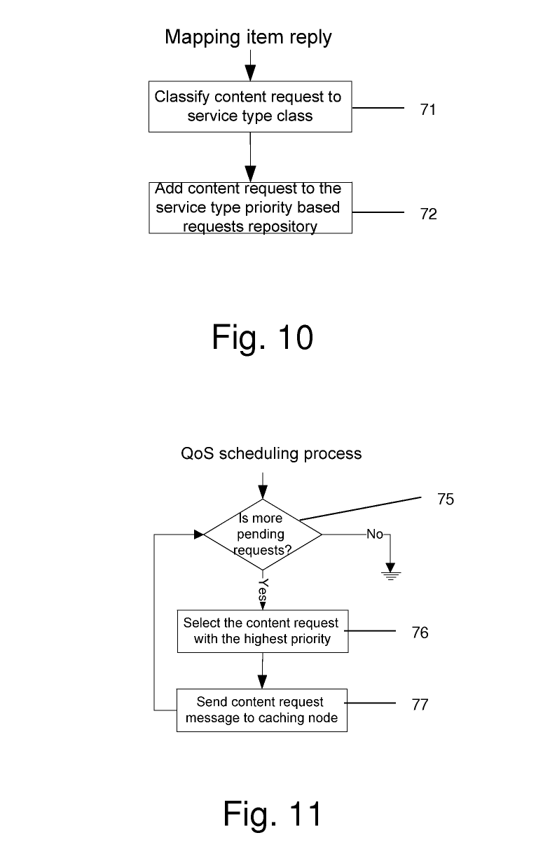

The classification process within a requesting node is illustrated in FIG. 10. Following reception of a content mapping reply message from a mapping node in the pull mode, or reception of disseminated mapping information in the push mode:
1. Classifying the content retrieval request in step 71 according to the user-specific service type identifier, whether in the pull mode or in the push mode.
2. Adding a classified content retrieval request message into a “waiting to be handled” priority based, content request repository table. The repository table will be used by the QoS aware scheduling process.

FIG. 11 illustrates a QoS aware scheduling process within the access node. Upon start of the scheduling process:
1. If no more pending content retrieval requests remain in the repository table, the process is terminated in step 75. Otherwise,
2. Selecting in step 76 the content retrieval request with the highest priority based on service type category.
3. Sending the content retrieval request message in step 77 to the caching node identified in the content mapping reply message together with the content identifier and service type identifier.

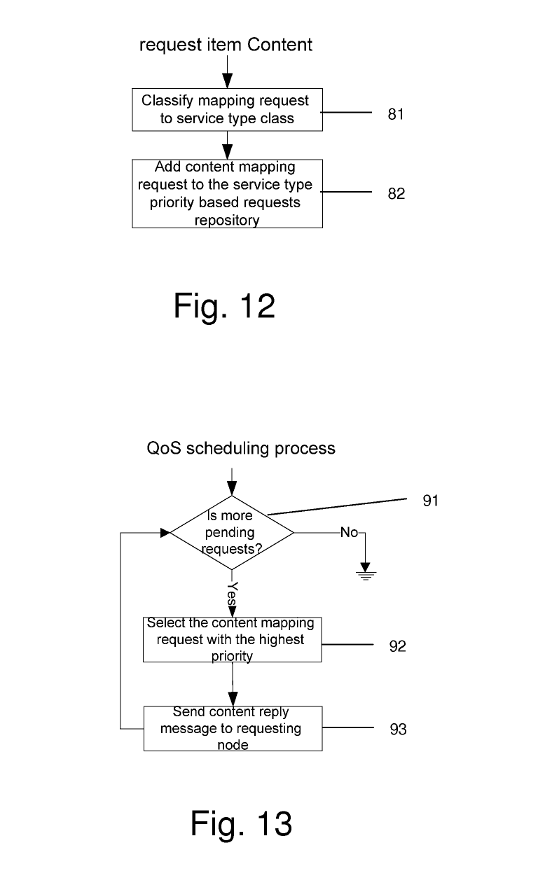

FIG. 12 illustrates the classification process within the targeted caching node. The content retrieval requests have to be prioritized since the caching node transmits content to a plurality of access nodes. Upon reception of a content retrieval request:
1. Classify the content retrieval request in step 81 according to the service type identifier received in the message.
2. Adding the classified content retrieval request into a “waiting to be handled” priority based, content retrieval request repository table. The repository table will be used by the QoS aware scheduling process.

FIG. 13 illustrates the QoS aware scheduling process within the caching node.

Upon start of the scheduling process:
1. If no more pending content retrieval requests remain in the repository table, the process is terminated in step 91. Otherwise,
2. Selecting in step 92 the content retrieval request with the highest priority based on service type category.
3. Sending in step 93 the content retrieval reply message, together with the retrieved content, to the requesting node for delivery to the end user.

Prioritization is also performed during the delivery phase in order to utilize limited bandwidth when more than one end user is expected to receive the same content.

As can be appreciated by the foregoing description, the caching management method of the present invention efficiently, cost effectively and quickly manages cache related content retrieval and delivery, as well as assigning the previously guaranteed user-specific priority to the retrieved content, by relying on the existing communication infrastructure to obtain QoS related information for RF purposes. The QoS aware RF connection thereby facilitates QoS aware caching. This way, each content request that arrives at a mapping node will include an identifier that is indicative of the priority that will be granted to the corresponding end user. This approach saves overhead in the form of internetwork packet inspection that is required in prior art caching management methods in order to assign the correct priority to the retrieved content.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A pull based caching management method for delivering retrieved content over a wireless data network, comprising the steps of:
a) deploying each of a plurality of distributed caches at corresponding access nodes located at an edge of a wireless network;
b) deploying, at corresponding access nodes, at least one mapping node for mapping the location of cached content;
c) receiving, from a mobile device, a request for content at one of said access nodes which thereby serves as a requesting node;
d) classifying said request to QoS once for each user, to generate a quality of service (QoS) type identifier associated with a user of said mobile device;
e) at said requesting node, receiving said quality of service (QoS) type identifier and attaching said received QoS identifier and an identifier of said requested content to a content mapping request message;
f) scheduling the handling of the mapping request message, based on the priority that corresponds to the QoS type, on the mapping node;
g) transmitting said content mapping request message to a selected mapping node with a corresponding QoS identifier;
h) receiving from said selected mapping node, at said requesting node, a content mapping reply message that includes an identifier of one or more target caching nodes at which the requested content is stored;
i) scheduling the handling of the content request, based on the priority that corresponds to the type of QoS, on the caching node;
j) transmitting a content retrieval request message that includes said QoS identifier and said requested content identifier, from said requesting node to said one or more target caching nodes; and
k) receiving in return, at said requesting node, a content retrieval reply message together with retrieved content in accordance with said QoS identifier.

2. The method according to claim 1, wherein the requesting node classifies the content request according to a service type category by referring to the received QoS type identifier and adds the classified content request to a priority based mapping table repository prior to transmitting the content mapping request message.

3. The method according to claim 2, wherein the selected mapping node classifies a priority level of the content mapping request with respect to content mapping requests received from other requesting nodes and adds the classified content mapping request to a priority based mapping table repository prior to transmitting the content mapping reply message.

4. The method according to claim 3, further comprising scheduling the handling of the mapping request, based on the priority that corresponds to the QoS type, on the mapping node.

5. The method according to claim 2, further comprising scheduling the handling of the mapping request, based on the priority that corresponds to the QoS type, on the requesting node.

6. The method according to claim 3, wherein the selected mapping node obtains a list of caching nodes in which the requested content is stored, for a highest priority mapping request, and sends said list together with the content mapping reply message.

7. A push based caching management method for delivering retrieved content over a wireless data network, comprising the steps of:
a) deploying each of a plurality of distributed caches at corresponding access nodes located at an edge of a wireless network;
b) deploying, at corresponding access nodes, a plurality of mapping nodes for mapping the location of cached content, wherein each of said mapping nodes is provided with predetermined user-specific instructions for predetermined users, including instructions for triggering a content retrieval operation and also QoS parameters;
c) receiving, at a first of said mapping nodes, a content update triggering event message;
d) disseminating, from said first mapping node to one or more other mapping nodes, mapping information of said updated content;
e) receiving from one of said plurality of mapping nodes, at one of said access nodes serving as a requesting node, a content mapping request message that includes a content identifier associated with said updated content, an identifier of one or more target caching nodes at which said updated content is stored, and said user-specific QoS parameters;
f) transmitting a content retrieval request message that includes said QoS parameters and said content identifier, from said requesting node to said one or more target caching nodes; and
g) receiving in return, at said requesting node, a content retrieval reply message together with retrieved content in accordance with said QoS parameters.

8. The method according to claim 7, wherein the mapping node classifies a priority level of dissemination of local and other peer's content mapping tables, to be performed at discrete periods of times.

9. The method according to claim 8, further comprising scheduling the dissemination of local and other peer's content mapping tables, to be performed once every predefined interval.

10. The method according to claim 3, wherein the mapping node obtains a list of caching nodes in which the content is stored, for a highest priority mapping request, and sends said list together with the content mapping reply message.

11. The method according to claim 1, wherein classification is based on any combination of the following:
the QoS categories and classification defined and used within the system;
a standalone system for adding the support for QoS;
different user profiles;
content providers profiles;
regional/physical location of entities.

12. The method according to claim 1, wherein the scheduling process is done in any requesting and replying nodes within both discovery and delivery phases, based on the relevant QoS class of the requesting user.

13. The method according to claim 1, wherein during a discovery phase, a peer holding a cached item prioritizes content delivery to requesting nodes according to quality of service types.

14. The method according to claim 1, wherein an operator defines within the management system any nodes to be prioritized over other nodes.

15. The method according to claim 1, wherein during a delivery phase, a peer holding a cached item will prioritize content delivery to requesting nodes according to quality of service types.

16. The method according to claim 1, wherein prioritization is assisted by a central database, which stores QoS related data for all end users.

17. The method according to claim 1, wherein the dissemination process is performed at discrete periods of times, or alternatively once every predefined interval. The dissemination process may be based on for example efficient bloom filters for content mapping representation in nodes.

18. The method according to claim 7, wherein the dissemination of mapping tables is based on QoS level of content, according to which, the mapping tables with the highest priority content will be disseminated first, and then the remanding mapping tables, according to a descending order of their corresponding priorities.

19. The method according to claim 7, wherein classification is based on any combination of the following:
the QoS categories and classification defined and used within the system;
a standalone system for adding the support for QoS;
different user profiles;
content providers profiles;
regional/physical location of entities.

20. The method according to claim 7, wherein the scheduling process is done in any requesting and replying nodes within both discovery and delivery phases, based on the relevant QoS class of the requesting user.

21. The method according to claim 7, wherein during a discovery phase, a peer holding a cached item prioritizes content delivery to requesting nodes according to quality of service types.

22. The method according to claim 7, wherein an operator defines within the management system any nodes to be prioritized over other nodes.

23. The method according to claim 7, wherein during a delivery phase, a peer holding a cached item will prioritize content delivery to requesting nodes according to quality of service types.

24. The method according to claim 7, wherein prioritization is assisted by a central database, which stores QoS related data for all end users.
